(19) United States
(12) Patent Application Publication
(10) Pub. No.: US 2026/0070797 A1
(43) Pub. Date: Mar. 12, 2026

(54) PREPARATION METHOD AND USE OF FUNCTION TYPE ACTIVE ALUMINOSILICATE

(71) Applicant: FUZHOU UNIVERSITY, Quanzhou, Fujian (CN)

(72) Inventors: Yuanyuan YUE, Quanzhou, Fujian (CN); Peng DONG, Quanzhou, Fujian (CN); Xiaojun BAO, Quanzhou, Fujian (CN); Chan WANG, Quanzhou, Fujian (CN); Yanhai WANG,, Quanzhou, Fujian (CN); Haibo ZHU, Quanzhou, Fujian (CN); Qingyan CUI, Quanzhou, Fujian (CN)

(73) Assignee: FUZHOU UNIVERSITY, Quanzhou, Fujian (CN)

(21) Appl. No.: 17/764,956

(22) PCT Filed: Dec. 17, 2021
(86) PCT No.: PCT/CN2021/139215

§ 371 Date: Nov. 11, 2025

(30) Foreign Application Priority Data
Nov. 24, 2021 (CN) 202111401128.5

(51) Int. Cl. C01B 39/38; B01J 29/40; C01B 33/26

(52) U.S. Cl. CPC C01B 39/38; B01J 29/40; C01B 33/26; C01P 2002/72

(57) ABSTRACT

The disclosure provides a preparation method and use of function type active aluminosilicate. The method comprises the steps: mixing and pulping a natural aluminosilicate mineral, an organic acid salt and an alkali metal hydroxide solution, and respectively depolymerizing and carbonizing the natural aluminosilicate mineral and the organic acid salt in slurry in a spray drier. The prepared aluminosilicate can be used for synthesis of a hierarchical molecular sieve in which the contained high-active silica and alumina species provide the silicon and aluminum sources for synthesizing the hierarchical molecular sieve, and the contained carbon particles serve as mesoporous template agent for synthesizing the hierarchical molecular sieve. According to the disclosure, the depolymerization time of the natural aluminosilicate mineral is obviously shortened, and the continuous depolymerization of the aluminosilicate mineral can be realized, thereby facilitating large-scale production; and meanwhile the carbon particles in the material prepared in the disclosure are highly dispersed in the active aluminosilicate, thereby effectively avoiding a problem that the carbon material is easily separated from a silica and alumina raw material when serving as the mesoporous template for synthesis of the molecular sieve so as to provide an efficient and feasible method for the synthesis of hierarchical molecular sieve.

### FIELD OF TECHNOLOGY

The disclosure belongs to the field of comprehensive utilization of natural aluminosilicate minerals, relates to a preparation method and use of a function type active aluminosilicate, and particularly relates to an aluminosilicate containing high-active silicon and aluminum species and high-dispersion carbon particles and obtained by mixing and pulping a natural aluminosilicate mineral, an organic acid salt and an alkali metal hydroxide solution and then depolymerizing and carbonizing in a spray drier. The function type active aluminosilicate of the disclosure provides high-active silicon and aluminum sources and a mesoporous template agent for the synthesis of a hierarchical molecular sieve.

### BACKGROUND

Molecular sieve is a porous aluminosilicate material which is formed by interconnecting oxygen atoms on vertexes of a TO₄ (in which T is Si and Al, etc.) tetrahedra, has different porous channel dimensionality with a ordered porous channel and/or a cage structure of 3-12 Å. The molecular sieve is widely applied in the fields of catalysis, separation, ion exchange and so on due to its unique structure and properties.

In industry, most of molecular sieves are synthesized by hydrothermal crystallization using silicon-containing and aluminum-containing inorganic chemicals with high purity and high reactivity as raw materials. The method of molecular sieves synthesis based on inorganic chemicals have the advantages of mature process, high product quality, easily controlled process conditions and so on, but they still have many problems: first, most of the used inorganic chemicals are prepared from natural aluminosilicate minerals by complicated reactions and separation processes, the production process is long in process route and high in energy and material consumption, and there exist in serious pollution emission in most of the processes; second, the price of these inorganic chemicals are expensive, which results in high cost for synthesis of molecular sieve so that the industrial application of molecular sieves is seriously affected. Therefore, to achieve green production of molecular sieves and reduction in their production costs, many researchers have attempted to synthesize the molecular sieves by directly using natural aluminosilicate minerals with extensive source and cheap price. Such the process route can promote the utilization value of resources and greatly decrease the production cost, and has a significant development prospect.

However, although a large amount of silicon and aluminum elements are rich in the natural aluminosilicate minerals, basic skeletons of these minerals are all formed by connecting silicon-oxygen polyhedrons with aluminum-oxygen polyhedrons in various manners, and most of these polyhedrons are connected in a manner of sharing angular tops in most cases to form crystal structures with stable frame-shaped, layer-shaped, chain-shaped, ring-shaped, island-shaped skeletons or the like; hence, the natural aluminosilicate minerals are difficultly used for direct synthesis of molecular sieves due to their low chemical reactivity, and thus need to be activated. As is well known, the essence of the activation of the natural aluminosilicate minerals is that the silicon-oxygen polyhedrons and the aluminum-oxygen polyhedrons in them are depolymerized into an oligomeric aluminosilicate with high reactivity.

Currently, the most commonly used depolymerization methods of natural minerals include a high-temperature thermal activation and a alkali fusion activation. The high-temperature thermal activation method is that the natural aluminosilicate minerals are calcined at high temperature to destroy Si—O bond and Al—O bond in a crystal structure to improve their reactivity, but this method is high in energy consumption and can only partially activate silicon and aluminum in the natural aluminosilicate minerals, thereby resulting in a large amount of unreacted minerals left in a product. The alkali fusion activation method is that sodium hydroxide or sodium carbonate is often used to be mixed with natural minerals and then calcined, which is intended to transform the long range ordered lattice structure of the natural minerals into a long range disordered and short range ordered vitreous body; however, the alkali fusion activation method is still a high-energy consumption process (the reaction temperature must be higher than the melting point of alkali), and the solid alkali reacts with aluminosilicate minerals to form a melt with high viscosity, so the diffusion rate of reactants is slow, leading to a fact that the surface of the mineral particle is easily activated, and its inside is difficultly activated. Both of the above two depolymerization methods are that the silicon-oxygen polyhedron and the aluminum-oxygen polyhedron of the natural mineral are depolymerized into the oligomeric crystal structures to be expected to obtain high-active oligomeric silica-alumina tetrahedrons, however, a series of problems existing in the two methods restrict their industrial application. Therefore, whether efficient depolymerization of natural aluminosilicate minerals in low energy and material consumption is a key to synthesize molecular sieves by effectively utilizing the natural aluminosilicate minerals.

CN103570032A discloses a method for preparing an active aluminosilicate. This method specifically comprises: natural aluminosilicate minerals react in an alkali metal hydroxide solution having a concentration of more than 350 g/L at 150-300° C. under an atmospheric open system, the product is diluted with water until pH is less than 10, then filtered and separated, so as to obtain an oligomeric high-active aluminosilicate and an alkali metal hydroxide aqueous solution that can be reused. In this activation process, the alkali metal hydroxide aqueous solution after being concentrated is reused with high energy consumption; the activation process is intermittent and the activated product is easily adhered to the wall of a vessel and difficult to separate from a device. The above defects limit the large-scale industrial application of this process.

WO201678035A1 discloses an active aluminosilicate material and a preparation method thereof. This preparation method specifically comprises: a natural aluminosilicate mineral, an alkali metal hydroxide and water are kneaded and extruded to form strips, and then the strips are activated by a sub-molten salt at 150˜300° C. to obtain the active aluminosilicate material which can serve as silicon and aluminum sources with high reactivity for synthesis of molecular sieves. This activation process does not completely avoid a problem that the activated product is easily adhered to the wall of the vessel, the mixture of the natural aluminosilicate mineral, the alkali metal hydroxide and water can continuously release heat during the extrusion of strips, so as to cause water to be evaporated to result in that the mixture is caked in a banded extruder, which is disadvantageous to extrusion and formation of the product. This process can seriously abrade equipment; in addition, the activation and product drying processes are time-consuming and low in aging, which is disadvantageous to industrial production.

In both CN 103570032A and WO 2016078035A1, the natural aluminosilicate mineral is transformed into the oligomeric aluminosilicate with high reactivity in a sub-molten salt system. The sub-molten salt medium has excellent physiochemical properties such as low steam pressure, good fluidity, high activity coefficient and high reaction activity, can provide negative oxygen ions with high chemical reactivity, and thus accelerate the reaction rate. The Si—O bonds and the Al—O bonds in the natural aluminosilicate mineral are both destroyed after being activated by the sub-melt salt. Specifically, polymerized silicon is depolymerized into the oligomeric aluminosilicate, and six-coordinated aluminum is transformed into high-reactivity four-coordinated aluminum. However, since large amount of alkali metal hydroxide in the sub-melt salt system, the processes involved in CN 103570032A and WO 2016078035A1 has the problem that the wall of the vessel is adhered, has high requirements for equipment. Furthermore, the finally activated product is in a shape of bulk or strip, so it needs to be further grinded if being used for synthesizing molecular sieves, and the process is tedious.

With the development of science and technologies, various properties of conventional microporous molecular sieve materials have no longer met the increasing requirements of many application fields, and how to achieve the high-performance preparation of molecular sieves has already been a research hotspot in recent years. Although the traditional microporous molecular sieves have many advantages of good stability, large specific surface area and so on, their porous channel and porous size are both relatively small. In the reaction process which macromolecules are involved in, the diffusion of reactants and products in the microporous channel of the molecular sieve can be seriously limited, which not only reduces the reaction efficiency and the selectivity of the target product but also makes the molecular sieve easily inactivated due to carbon deposition, thereby greatly shortening their catalytic life. In order to lift the restriction of sole micropore of microporous molecular sieve, the researchers have committed to preparing a hierarchical molecular sieve with the advantages of hydrothermal stability and acidity equivalent to those of the microporous molecular sieve and a certain amount of mesopores or macropores.

At present, preparation methods of hierarchical molecular sieves mainly include two methods: the first method is a post-treatment method; the second method is a direct synthesis method. The post-treatment method for preparing the hierarchical molecular sieve is easy to operate, but cannot control the mesopore size, and can also damage the skeleton of the molecular sieve. After treatment, a large amount of waste acid/base solution is produced, which is not a green process. The direct synthesis method mainly includes a soft template method and a hard template method. The soft template method needs to use a macroporous/mesoporous template with complex preparation and high cost, and the removal of the template can also cause environmental pollution so that it is difficult to be used on a large scale. On the other hand, the hard template method refers to using a solid template agent with a space filling function to replace a macromolecular surfactant to form porous channels in the process of synthesizing the materials. A carbon-based template agent is the most typical hard template, including carbon particles, carbon nanotubes, etc. The process for synthesizing a hierarchical molecular sieve by the hard template method is as follows: a silicon source, an aluminum source, an alkali and water are mixed to obtain a silica and alumina gel, and then a hard template agent such as carbon particles is added; subsequently, the synthesized product is calcined to remove the template; finally, a hierarchical molecular sieve with mesopores is obtained. Although the hard template method is relatively simple in synthesis process and easy to operate, the porous wall of the molecular sieve has high crystallinity, and the hard template agent is a carbon material in most cases, and is cheap and easily available. However, in the synthesis process of the hard template method, phase separation easily occurs between the hard template agent and silicon and aluminum species so that the hard template agent difficultly participates in the synthesis of the molecular sieve, resulting in low utilization rate of the hard template agent in the synthesis process and poor synthesized product performance.

### SUMMARY OF THE INVENTION

In order to solve the above problems, the objective of the disclosure is to provide an efficient and simplified preparation method of a function type active aluminosilicate, wherein the high-active aluminosilicate and carbon particles respectively serve as silicon and aluminum sources and a mesoporous template agent for synthesis of a hierarchical molecular sieve.

The disclosure provides a preparation method of a function type active aluminosilicate, specifically comprising: a natural aluminosilicate mineral, an organic acid salt and an alkali metal hydroxide solution are mixed and pulped, and then the natural aluminosilicate mineral and the organic acid salt in slurry are respectively depolymerized and carbonized in a spray drier to obtain an aluminosilicate containing a high-active silicon and aluminum species and highly dispersed carbon particles.

The preparation method of the function type active aluminosilicate comprises the following specific implementation process steps:
(1) preparation of an alkali metal hydroxide solution: preparing an alkali metal hydroxide into the alkali metal hydroxide solution under the condition of violent stirring;
(2) mixing and pulping: mixing the natural aluminosilicate mineral, the organic acid salt and the alkali metal hydroxide solution in a certain proportion, and stirring for 10-120 min at a rotation speed of 600-1600 rpm to obtain slurry;
(3) spray depolymerization and carbonization: setting the temperatures of an inlet and an outlet of a spray drier as 120-250° C. and 50-150° C., respectively, then pouring the slurry from the inlet of the spray drier and dispersing the slurry into 10-30 μm droplets via an airflow type atomizer with a compressed air pressure of 0.2-0.5 MPa, allowing the obtained droplets to enter a drying chamber of 160-280° C. to be in direct contact with high-temperature hot air, wherein at this moment, the droplets undergo a sudden high temperature so that the natural aluminosilicate mineral and the organic acid salt are respectively depolymerized and carbonized during this process, and making the droplets stay for 30-300 s in the drying chamber and then spraying the dried droplets out from the outlet of the spray drier to obtain a powdered solid.

The main purpose of spraying in the disclosure is that the atomizer of the spray dryer is utilized to disperse the slurry into droplets, and then the hot air is in direct contact with the droplets, which completely avoids the problem that the product is easily adhered to the wall of the vessel, thereby reduces the requirement on the equipment, and greatly increases a heat transfer area during depolymerization, improves the depolymerization rate of natural aluminosilicate minerals, has low energy consumption, and can realize continuous production. In the synthesis of most molecular sieve, there is a need to provide an alkali source. In the disclosure, the depolymerized natural aluminosilicate mineral can directly serve as a part of the alkali source for synthesizing the molecular sieve without separating the alkali metal hydroxide.

After the natural aluminosilicate mineral, the organic acid salt and the alkali metal hydroxide solution in the above method are strongly stirred and uniformly mixed, the obtained slurry is dispersed into droplets via the atomizer. The organic acid salt is carbonized at sudden high temperature and decomposed into carbon particles and a metal oxide. The temperature of the drying chamber in the above method is set to 160˜280° C., the drying chamber is at a high temperature, and the organic acid salt in the droplets can be carbonized to form carbon particles after entering the drying chamber, and meanwhile the Si—O bonds and the Al—O bonds in the silicon-oxygen polyhedrons and aluminum-oxygen polyhedrons in the natural aluminosilicate minerals are both destroyed under the action of alkali metal hydroxide, and polymeric silicon and aluminum species are depolymerized into oligomeric aluminosilicates, and the obtained active aluminosilicate and carbon particles can be used as silicon and aluminum sources and a mesoporous template agent for synthesis of hierarchical molecular sieves, respectively. The organic acid salt used in the disclosure can be dissolved into the alkali metal hydroxide solution, so when the slurry is prepared, the natural aluminosilicate mineral is also dispersed into the organic acid salt solution, and the carbon particles obtained by carbonization and decomposition of the organic acid salt in the slurry are highly dispersed in the active aluminosilicate obtained by depolymerization of the natural aluminosilicate mineral, thereby effectively avoiding a problem that the carbon particles are easily separated from the molecular sieve when serving as the mesoporous template agent, improving the utilization efficiency of the template agent, and facilitating the efficient synthesis of the hierarchical molecular sieve. Due to the uniform distribution of the carbon particles in the aluminosilicate, the carbon particles are closely combined with raw materials in the synthesis process of molecular sieves, which is conducive to improving the utilization efficiency of the carbon particles as a hard template agent and then promoting the efficient synthesis of the hierarchical molecular sieve. The hierarchical molecular sieve synthesized by using a function type aluminosilicate as a raw material can be used in catalytic cracking, hydrocracking, hydrodesulfurization and other catalytic reactions where the large molecules are involved, which is conducive to diffusion of reactants and products, improvement of the reaction rate and selectivity of target products and reduction in side reactions.

The droplets in the above method stay in the drying chamber for 30-300 s. According to the specific embodiment of the disclosure, the staying time of droplets is different due to different alkali amounts, different water amounts and different organic acid salt qualities required by different natural aluminosilicate minerals. In the disclosure, the droplets obtained by dispersing the slurry via the atomizer can be completely dried in the drying chamber without additional drying, thereby reducing time cost. The product in the disclosure is powdered, and can be directly used for the synthesis of molecular sieves without grinding, thereby simplifying the process flow.

The mass ratio of the natural aluminosilicate mineral to the organic acid salt in the above method is 4-10:1. According to the specific embodiment of the disclosure, a mass ratio of the natural aluminosilicate mineral to the organic acid salt in the slurry is changed to prepare the active aluminosilicates with different carbon contents, and then different types of hierarchical molecular sieves are synthesized using the function type active aluminosilicates with different carbon contents as raw materials.

The alkali metal hydroxide in the above method is one or more of NaOH, KOH and LiOH, and the alkali metal hydroxide solution is an alkali metal hydroxide aqueous solution whose concentration is 0.05-0.3 g/mL.

The natural aluminosilicate mineral in the above method comprises one or more of feldspar, nepheline, leucite, beryl, muscovite, pyrophyllite, kaolinite, rectorite, jadeite, spodumene, diaspore, perlite, cordierite, phlogopite, vermiculite, montmorillonite, talc, serpentine, illite, palygorskite, sepiolite, attapulgite, enstatite, diopside, amphibole and olivine.

The organic acid salt in the above method comprises one or more of sodium citrate, sodium tartrate, sodium malate, sodium oxalate, potassium citrate, potassium tartrate, potassium malate, potassium oxalate, lithium citrate, lithium tartrate, lithium malate and lithium oxalate.

The natural aluminosilicate mineral has an impurity content of less than 20 wt % and a particle size of no more than 200 mesh, and a ratio of the natural aluminosilicate mineral to the alkali metal hydroxide aqueous solution is 0.05-0.5 g/mL.

Further, the function type active aluminosilicate prepared according to the disclosure is used for synthesis of a hierarchical molecular sieve. The specific synthesis process is to uniformly mix sodium hydroxide, an active aluminosilicate, a supplementary silicon source, crystal seeds and deionized water, and then perform aging and hydrothermal crystallization to obtain the hierarchical molecular sieve.

The supplementary silicon source in the above method is one or more of white carbon black, silica sol, sodium silicate or industrial silica gel.

A catalyst is prepared by using the hierarchical molecular sieve in the above method and used for catalytic cracking reaction of heavy oil or hydrocracking reaction of inferior catalytic diesel oil.

The disclosure has the beneficial effects:
(1) The preparation method provided by the disclosure has the advantages of low equipment requirements, high aging, simple process, low energy consumption, high mineral utilization rate, wide raw material source and easy implementation and popularization. The product of the disclosure is powdered, easy to store and transport, and conducive to industrial large-scale application. According to the disclosure, inert natural aluminosilicate minerals can be simultaneously depolymerized into oligomeric aluminosilicates and organic acid salts are carbonized into carbon particles, and aluminosilicates containing high-active silica-alumina species and highly dispersed carbon particles are finally prepared. The different types of hierarchical molecular sieves can be directly synthesized by using these aluminosilicates as raw materials without additional mesoporous template agent, so as to provide rich raw materials for the synthesis of hierarchical molecular sieves.
(2) According to the disclosure, the hierarchical molecular sieve is synthesized by using the prepared function type active aluminosilicate as the raw material, and is used for catalytic cracking reaction of heavy oil or hydrocracking reaction of inferior catalytic diesel oil, thereby gaining remarkable effects: compared with the commercial microporous molecular sieves, under the same reaction conditions, the catalyst containing the hierarchical molecular sieve synthesized according to the disclosure has better catalytic performance, can significantly improve the yield of target distillate oil and reduce the yield of coke.

### BRIEF DESCRIPTION OF THE DRAWINGS

FIG. 1 is an X-ray diffraction (XRD) pattern of a molecular sieve obtained in example 1.

FIG. 2 is a porous diameter distribution curve of a molecular sieve obtained in example 1.

FIG. 3 is an XRD pattern of a molecular sieve obtained in example 2.

FIG. 4 is a porous diameter distribution curve of a molecular sieve obtained in example 2.

FIG. 5 is an XRD pattern of a molecular sieve obtained in example 3.

FIG. 6 is a porous diameter distribution curve of a molecular sieve obtained in example 3.

FIG. 7 is an XRD pattern of a molecular sieve obtained in example 4.

FIG. 8 is a porous diameter distribution curve of a molecular sieve obtained in example 4.

FIG. 9 is an XRD pattern of a molecular sieve obtained in example 5.

FIG. 10 is a porous diameter distribution curve of a molecular sieve obtained in example 5.

FIG. 11 is an XRD pattern of a molecular sieve obtained in comparative example 1.

FIG. 12 is a porous diameter distribution curve of a molecular sieve obtained in comparative example 1.

FIG. 13 is an XRD pattern of a molecular sieve obtained in comparative example 2.

FIG. 14 is a porous diameter distribution curve of a molecular sieve obtained in comparative example 2.

FIG. 15 is an XRD pattern of a molecular sieve obtained in comparative example 3.

FIG. 16 is a porous diameter distribution curve of a molecular sieve obtained in comparative example 3.

### DESCRIPTION OF THE EMBODIMENTS

Next, the disclosure will be further described in combination with specific embodiments, which is intended to illustrate the embodiments and features of the disclosure in detail, and cannot understand as limiting the disclosure.

The depolymerization method in embodiments is performed as follows: a natural aluminosilicate mineral, an organic acid salt and an alkali metal hydroxide solution are mixed and pulped, and then the natural aluminosilicate mineral and the organic acid salt in slurry are respectively depolymerized and carbonized in a spray drier to obtain an aluminosilicate containing high-active silicon and aluminum species and highly dispersed carbon particles, which can directly serve as a raw material for the synthesis of a hierarchical molecular sieve.

The contents of active SiO₂ and Al₂O₃ in the minerals are defined as SiO₂ and Al₂O₃ which are formed in the process of activation, can be extracted by acid or alkali and serve as raw materials for synthesis of molecular sieves (Wei B., Liu H., Li T., Cao L., Fan Y., Bao X. AIChE Journal; 2010, 56 (11), 2913-2922).

The active silica and alumina species in embodiments are determined as follows: a certain amount of the above aluminosilicate is weighed and added into a HCl solution, stirred at room temperature for 2 h. After the reaction is completed, the solution is filtered to obtain an acidic solution containing the active silica and alumina species, and the contents of Si and Al elements in the acidic solution are analyzed by inductively coupled plasma emission spectrometry (ICP-OES). The content of active alumina and silica in a sample is calculated according to the following equation:

$$Content of active alumina ( silica ) = \frac{Weight of alumina ( silica ) extracted from liquid phase}{Weight of alumina ( silica ) in raw material} \times 100 \%$$

### Example 1

The natural aluminosilicate mineral used in this example is natural kaolinite (purchased from China Kaolin Company, and a particle size is less than 300 mesh). The natural kaolin contains 53.1 wt % SiO₂ and 44.1 wt % Al₂O₃. The organic acid salt used in this example is sodium tartrate. The alkali metal hydroxide used in this example is sodium hydroxide.

### Step S1 Depolyerization of natural kaolinite and carbonization of sodium tartrate

0.08 g/mL sodium hydroxide solution was prepared, then 100 g of natural kaolinite, 25 g of sodium tartrate and 1200 mL of sodium hydroxide solution were mixed and stirred at a rotation speed of 1600 rpm/min for 15 min, this slurry was subsequently dispersed into 12 μm droplets in an air flow type atomizer at a pressure of 0.5 MPa, the obtained droplets were depolymerized in a drying chamber of 160° C., an inlet temperature and an outlet temperature of a spray drying tower were 120° C. and 60° C. respectively, and the slurry stayed for 300 s in the drying chamber. By determination, the depolymerized product has an active SiO₂ content of 98 wt % and an active Al₂O₃ content of 97 wt %.

### Step S2 Synthesis of ZSM-5 molecular sieve

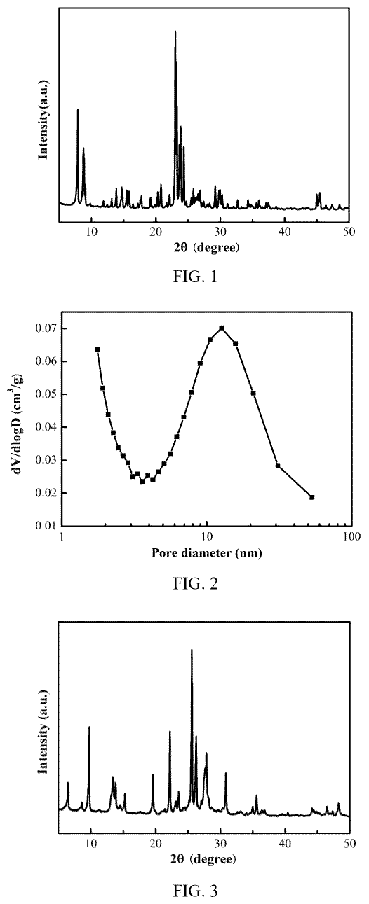

2.3 g of the above product, 0.7 g of sodium hydroxide solid, 12.0 g of industrial silica gel (90 wt % SiO₂), 0.2 g of ZSM-5 molecular sieve seeds and 68 mL of deionized water were added into a 100 mL of beaker and stirred for 4 h at 70° C., the above mixture was transferred to a stainless steel crystallized kettle with a Teflon lining and heated to 170° C. to be crystallized for 24 h. After crystallization was ended, the crystallized product was cooled, filtered and washed until the pH value was less than 9, and the washed product was dried overnight at 110° C. and roasted for 6 h at 550° C. to obtain a solid product. It can be seen from FIG. 1 that the obtained product is a pure ZSM-5 molecular sieve with a crystallization degree of 98%. It can be seen from FIG. 2 that the mesoporous diameter of the synthesized product mainly focuses on 4-50 nm, indicating that the synthesized ZSM-5 molecular sieve is a hierarchical molecular sieve.

### Example 2

The natural aluminosilicate mineral used in this example is natural rectorite (purchased from Hubei Mingliu rectorite Co., Ltd., and a particle size is less than 200 mesh). The natural rectorite contains 43.2 wt % SiO₂ and 37.2 wt % Al₂O₃. The organic acid salt used in this example is sodium malate. The alkali metal hydroxide used in this example is sodium hydroxide.

### Step S1 Depolymerization of natural rectorite and carbonization of sodium malate

0.17 g/mL sodium hydroxide solution was prepared, then 100 g of natural rectorite, 20 g of sodium malate and 700 mL of sodium hydroxide solution were mixed and stirred at a rotation speed of 1400 rpm/min for 30 min, this slurry was subsequently dispersed into 16 μm droplets in an air flow type atomizer at a pressure of 0.45 MPa, the obtained droplets were depolymerized in a drying chamber of 190° C., an inlet temperature and an outlet temperature of a spray drying tower were 160° C. and 80° C. respectively, and the slurry stayed for 250 s in the drying chamber. By determination, the depolymerized product has an active SiO₂ content of 99 wt % and an active Al₂O₃ content of 98 wt %.

### Step S2 Synthesis of mordenite

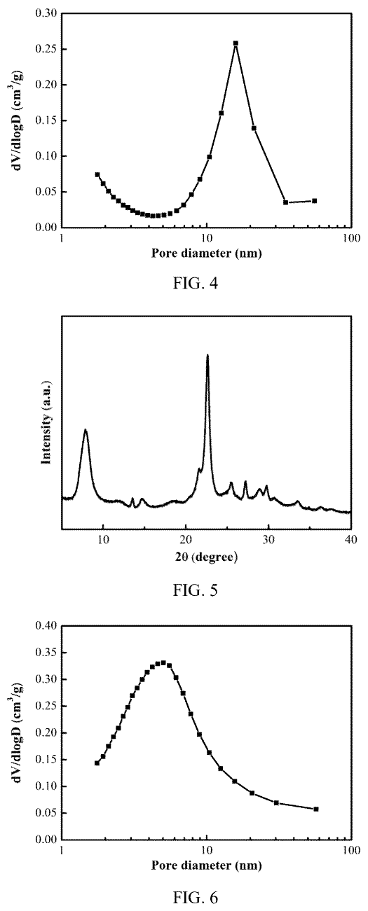

2.1 g of the product of Step S1 above, 0.8 g of sodium hydroxide solid, 7.7 g of industrial silica gel (90 wt % SiO₂) and 54 mL of deionized water were added into a 100 mL of beaker and stirred for 12 h at 60° C., the above mixture was transferred to a stainless steel crystallized kettle with a Teflon lining and heated to 170° C. to be crystallized for 16 h. After crystallization was ended, the crystallized product was cooled, filtered and washed until the pH value was less than 9, and the washed product was dried overnight at 110° C. and roasted for 6 h at 550° C. to obtain a solid product. It can be seen from FIG. 3 that the obtained product is a pure mordenite with a crystallization degree of 101%. It can be seen from FIG. 4 that the mesoporous diameter of the synthesized product focuses on 7-35 nm, indicating that the synthesized mordenite is a hierarchical molecular sieve.

### Example 3

The natural aluminosilicate mineral used in this example is natural kaolinite (purchased from China Kaolin Company, and a particle size is less than 300 mesh). The natural kaolin contains 53.1 wt % SiO₂ and 44.1 wt % Al₂O₃. The organic acid salt used in this example is sodium citrate. The alkali metal hydroxide used in this example is sodium hydroxide.

### Step S1 Depolymerization of natural kaolinite and carbonization of sodium citrate

0.20 g/mL sodium hydroxide solution was prepared, then 100 g of natural kaolinite, 15 g of sodium citrate and 500 mL of sodium hydroxide solution were mixed and stirred at a rotation speed of 1100 rpm/min for 60 min, then this slurry was dispersed into 21 μm droplets in an air flow type atomizer at a pressure of 0.4 MPa, the obtained droplets were depolymerized in a drying chamber of 210° C., an inlet temperature and an outlet temperature of a spray drying tower were 200° C. and 90° C. respectively, and the slurry stayed for 200 s in the drying chamber. By determination, the depolymerized product has an active SiO₂ content of 99 wt % and an active Al₂O₃ content of 99 wt %.

### Step S2 Synthesis of Beta molecular sieve

2.2 g of the product of Step S1 above, 0.3 g of sodium hydroxide solid, 21.6 g of silica gel (40 wt % SiO₂), 0.3 g of Beta molecular sieve seeds and 56 mL of deionized water were added into a 100 mL of beaker and stirred for 4 h at room temperature, the above mixture was transferred to a stainless steel crystallized kettle with a Teflon lining and heated to 140° C. to be crystallized for 18 h. After crystallization was ended, the crystallized product was cooled, filtered and washed until the pH value was less than 9, and the washed product was dried overnight at 110° C. and roasted for 6 h at 550° C. to obtain a solid product. It can be seen from FIG. 5 that the obtained product is a pure Beta molecular sieve with a crystallization degree of 99%. It can be seen from FIG. 6 that the mesoporous diameter of the synthesized product focuses on 2-10 nm, indicating that the synthesized Beta molecular sieve is a hierarchical molecular sieve.

### Example 4

The natural aluminosilicate mineral used in this example is natural rectorite (purchased from Hubei Mingliu Rectorite Co., Ltd., and a particle size is less than 200 mesh). The natural rectorite contains 43.2 wt % SiO₂ and 37.2 wt % Al₂O₃. The organic acid salt used in this example is sodium oxalate. The alkali metal hydroxide used in this example is sodium hydroxide.

### Step S1 Depolymerization of natural rectorite and carbonization of sodium oxalate

0.24 g/mL sodium hydroxide solution was prepared, then 100 g of natural rectorite, 12 g of sodium oxalate and 400 mL of sodium hydroxide solution were mixed and stirred at a rotation speed of 900 rpm/min for 90 min, then this slurry was dispersed into 26 μm droplets in an air flow type atomizer at a pressure of 0.3 MPa, the obtained droplets were depolymerized in a drying chamber of 230° C., an inlet temperature and an outlet temperature of a spray drying tower were 220° C. and 120° C., respectively, and the slurry stayed for 120 s in the drying chamber. By determination, the depolymerized product has an active SiO₂ content of 98 wt % and an active Al₂O₃ content of 99 wt %.

### Step S2 Preparation of structure-directing agent

3.5 g of NaAlO₂, 26 g of NaOH and 78 mL of water were weighed and successively added into a beaker, the obtained solution was cooled to room temperature after being clear and then dropwise added into 44.4 g of silica sol (40 wt % SiO₂), and the above mixture was stirred for 2 h at room temperature and aged for 36 h at 30° C. via standing to prepare the structure-directing agent.

### Synthesis of Y type molecular sieve

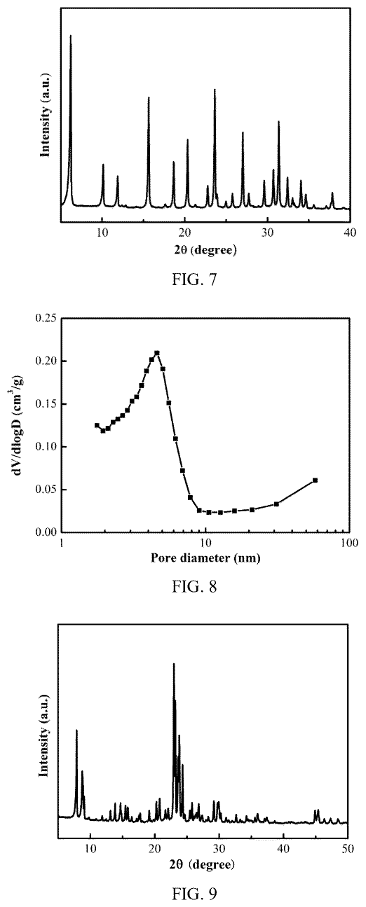

4.2 g of the product of Step S1 above, 0.2 g of sodium hydroxide solid, 15.1 g of water glass (8.95 wt % Na₂O and 27.68 wt % SiO₂), 3.3 g of structure-directing agent and 44 mL of deionized water were added into a 100 mL of beaker and stirred for 20 h at 60° C., the above mixture was transferred to a stainless steel crystallized kettle with a Teflon lining and heated to 100° C. to be crystallized for 26 h. After crystallization was ended, the crystallized product was cooled, filtered and washed until the pH value was less than 9, and the washed product was dried overnight at 110° C. and roasted for 6 h at 550° C. to obtain a solid product. It can be seen from FIG. 7 that the obtained product is a pure Y type molecular sieve with a crystallization degree of 96%. It can be seen from FIG. 8 that the mesoporous diameter of the synthesized product mainly focuses on 2-8 nm, indicating that the synthesized Y type molecular sieve is a hierarchical molecular sieve.

### Example 5

The natural aluminosilicate mineral used in this example is natural rectorite (purchased from Hubei Mingliu Rectorite Co., Ltd., and a particle size is less than 200 mesh). The natural rectorite contains 43.2 wt % SiO₂ and 37.2 wt % Al₂O₃. The organic acid salt used in this example is sodium tartrate. The alkali metal hydroxide used in this example is sodium hydroxide.

### Step S1 Depolymerization of natural rectorite and carbonization of sodium tartrate

0.30 g/mL sodium hydroxide solution was prepared, then 100 g of natural rectorite, 10 g of sodium tartrate and 250 mL of sodium hydroxide solution were mixed and stirred at a rotation speed of 600 rpm/min for 110 min, then this slurry was dispersed into 30 μm droplets in an air flow type atomizer at a pressure of 0.2 MPa, the obtained droplets were depolymerized in a drying chamber of 270° C., an inlet temperature and an outlet temperature of a spray drying tower were 250° C. and 140° C. respectively, and the slurry stayed for 300 s in the drying chamber. By determination, the depolymerized product has an active SiO₂ content of 99 wt % and an active Al₂O₃ content of 100 wt %.

### Step S2 Synthesis of ZSM-5 molecular sieve

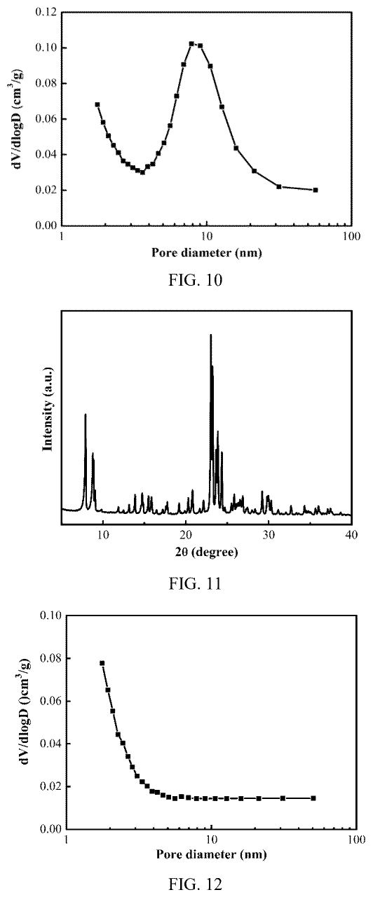

3.2 g of the product of Step S1 above, 1.5 g of sodium hydroxide solid, 17.5 g of white carbon black (SiO₂), 0.4 g of ZSM-5 molecular sieve crystal seeds and 75 mL of deionized water were added into a 100 mL of beaker and stirred for 4 h at 70° C., the above mixture was transferred to a stainless steel crystallized kettle with a Teflon lining and heated to 170° C. to be crystallized for 24 h. After crystallization was ended, the crystallized product was cooled, filtered and washed until the pH value was less than 9, and the washed product was dried overnight at 110° C. and roasted for 6 h at 550° C. to obtain a solid product. It can be seen from FIG. 9 that the obtained product is a pure ZSM-5 molecular sieve with a crystallization degree of 98%. It can be seen from FIG. 10 that the mesoporous diameter of the synthesized product mainly focuses on 3-30 nm, indicating that the synthesized ZSM-5 molecular sieve is a hierarchical molecular sieve.

### Comparative Example 1

In order to prove an interaction between deploymerization of a natural aluminosilicate mineral and carbonization of an organic acid salt, the deploymerization of the natural aluminosilicate mineral and the carbonization of the organic acid salt are separately conducted in this comparative example. The natural kaolinite has a SiO₂ content of 53.1 wt % and an Al₂O₃ content of 44.1 wt %. The organic acid salt used in this comparative example is sodium tartrate. The alkali metal hydroxide used in this comparative example is sodium hydroxide.

### Step S1 Depolymerization of natural kaolinite

0.08 g/mL sodium hydroxide solution was prepared, then 100 g of natural kaolinite and 1200 mL of sodium hydroxide solution were mixed and stirred at a rotation speed of 1600 rpm/min for 15 min, then this slurry was dispersed into 12 μm droplets in an air flow type atomizer at a pressure of 0.5 MPa, the obtained droplets were depolymerized in a drying chamber of 160° C., an inlet temperature and an outlet temperature of a spray drying tower were 120° C. and 60° C. respectively, and the slurry stayed for 300 s in the drying chamber. By determination, the depolymerized product has an active SiO₂ content of 97 wt % and an active Al₂O₃ content of 99 wt %.

### Step S2 Carbonization of sodium tartrate

25 g of sodium tartrate and 1200 ml of water were mixed and stirred for 15 min at a rotation speed of 1600 rpm/min, then this slurry was dispersed into 12 μm droplets in an air flow atomizer at a pressure of 0.5 MPa, the obtained droplets were depolymerized in a drying chamber of 160° C., an inlet temperature and an outlet temperature of a spray drying tower were 120° C. and 60° C. respectively, and the slurry stayed for 300 s in the drying chamber.

### Step S3 Synthesis of ZSM-5 molecular sieve

2.0 g of depolymerized product of natural kaolinite, 0.3 g of carbonized product of sodium tartrate, 0.7 g of sodium hydroxide solid, 12.0 g of industrial silica gel (90 wt % SiO₂), 0.2 g of ZSM-5 molecular sieve seeds and 68 mL of deionized water were added into a 100 mL of beaker and stirred for 4 h at 70° C., the above mixture was transferred to a stainless steel crystallized kettle with a Teflon lining and heated to 170° C. to be crystallized for 24 h. After crystallization was ended, the crystallized product was cooled, filtered and washed until the pH value was less than 9, and the washed product was dried overnight at 110° C. and roasted for 6 h at 550° C. to obtain a solid product. It can be seen from FIG. 11 that the obtained product is a pure ZSM-5 molecular sieve with a crystallization degree of 94%. It can be seen from FIG. 12 that the synthesized product has no obvious mesoporous distribution, indicating that the synthesized ZSM-5 molecular sieve is a microporous molecular sieve. It can be seen from comparative example 1 and example 1 that the deploymerized product and the carbonized product obtained by depolymerization of the natural aluminosilicate mineral and carbonization of the organic acid salt respectively are used as raw materials to only synthesize the microporous molecular sieve, indicating that the carbon particles obtained by the carbonization of the organic acid salt alone difficultly act as a mesoporous template in the synthesis process of molecular sieves.

### Comparative Example 2

In order to prove necessity of carbonization of organic acid salts, an uncarbonized organic acid salt is directly used in this comparative example. The natural aluminosilicate mineral used in this comparative example is natural kaolinite (purchased from China Kaolin Company, and a particle size is less than 300 mesh). The natural kaolin has a SiO₂ content of 53.1 wt % and an Al₂O₃ content of 44.1 wt %. The organic acid salt used in comparative example is sodium tartrate. The alkali metal hydroxide used in this comparative example is sodium hydroxide.

### Step S1 Depolymerization of natural kaolinite

0.08 g/mL sodium hydroxide solution was prepared, then 100 g of natural kaolin and 1200 mL of sodium hydroxide solution were mixed and stirred at a rotation speed of 1600 rpm/min for 15 min, then this slurry was dispersed into 12 μm droplets in an air flow type atomizer at a pressure of 0.5 MPa, the obtained droplets were depolymerized in a drying chamber of 160° C., an inlet temperature and an outlet temperature of a spray drying tower were 120° C. and 60° C. respectively, and the slurry stayed for 300 s in the drying chamber. By determination, the depolymerized product has an active SiO₂ content of 99 wt % and an active Al₂O₃ content of 97 wt %.

### Step S2 Synthesis of ZSM-5 molecular sieve

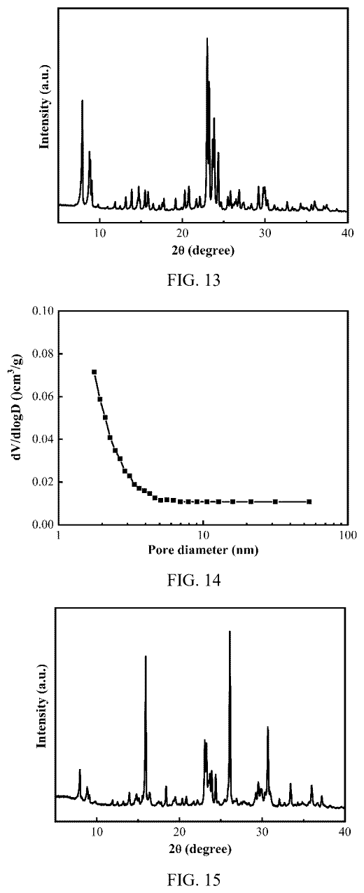

2.0 g of the product of Step S1 above, 0.3 g of sodium tartrate, 0.7 g of sodium hydroxide solid, 12.0 g of industrial silica gel (90 wt % SiO₂), 0.2 g of ZSM-5 molecular sieve seeds and 68 mL of deionized water were added into a 100 mL of beaker and stirred for 4 h at 70° C., the above mixture was transferred to a stainless steel crystallized kettle with a Teflon lining and heated to 170° C. to be crystallized for 24 h. After crystallization was ended, the crystallized product was cooled, filtered and washed until the pH value was less than 9, and the washed product was dried overnight at 110° C. and roasted for 6 h at 550° C. to obtain a solid product. It can be seen from FIG. 13 that the obtained product is a pure ZSM-5 molecular sieve with a crystallization degree of 96%. It can be seen from FIG. 14 that the synthesized product has no obvious mesoporous distribution, indicating that the synthesized ZSM-5 molecular sieve is a microporous molecular sieve. It can be seen from results of comparative example 2 and example 1 that the uncarbonized organic acid salt cannot act as a mesoporous template, and the direct use of the uncarbonized organic acid salt can only synthesize the microporous molecular sieve.

### Comparative Example 3

In order to prove the necessity of depolymerization of natural aluminosilicate minerals and carbonization of organic acid salts, the untreated natural aluminosilicate mineral and organic acid salt directly serve as synthesis raw materials of molecular sieves in this comparative example. The natural aluminosilicate mineral used in this comparative example is natural kaolin (purchased from China Kaolin Company, and a particle size is less than 300 mesh). The natural kaolin has a SiO₂ content of 53.1 wt % and an Al₂O₃ content of 44.1 wt %. The organic acid salt used in comparative example is sodium tartrate.

### Synthesis of ZSM-5 molecular sieve

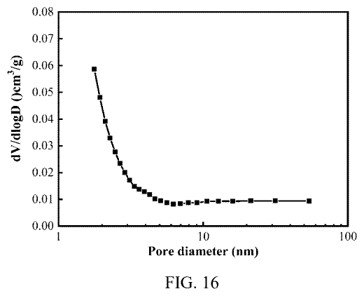

1.0 g of natural kaolinite, 0.3 g of sodium tartrate, 1.7 g of sodium hydroxide solid, 12.0 g of industrial silica gel (90 wt % SiO₂), 0.2 g of ZSM-5 molecular sieve seeds and 68 mL of deionized water were added into a 100 mL of beaker and stirred for 4 h at 70° C., the above mixture was transferred to a stainless steel crystallized kettle with a Teflon lining and heated to 170° C. to be crystallized for 24 h. After crystallization was ended, the crystallized product was cooled, filtered and washed until the pH value was less than 9, and the washed product was dried overnight at 110° C. and roasted for 6 h at 550° C. to obtain a solid product. It can be seen from FIG. 15 that the obtained product is a mixture of a ZSM-5 molecular sieve and sodalite, wherein the ZSM-5 molecular sieve has a crystallization degree of 37%. It can be seen from FIG. 16 that the synthesized product has no obvious mesoporous distribution, indicating that there are no mesopores in the synthesized product. It can be seen from results of comparative example 2 and example 1 that the direct use of the unreacted natural aluminosilicate mineral and organic acid salt as raw materials cannot synthesize the pure molecular sieve.

The hierarchical ZSM-5 molecular sieve synthesized in example 1, the microporous ZSM-5 molecular sieve synthesized in comparative example 1 and the microporous ZSM-5 molecular sieve synthesized in comparative example 2 are respectively applied to catalytic cracking of heavy oil. Xinjiang vacuum residues are selected as reactants, and the reaction is carried out on a micro-fixed fluidized bed. The reaction conditions are as follows: cracking temperature is 500° C., a mass ratio of an agent to oil is 10, a mass ratio of water to oil is 0.28, the injection time of feed oil is 45 s, and the loading amount of the catalyst is 50 g. The evaluation results are seen in Table 1. Compared with the microporous ZSM-5 molecular sieve synthesized in comparative example 1 and the microporous ZSM-5 molecular sieve synthesized in comparative example 2, in the product obtained by a catalyst prepared with the hierarchical ZSM-5 molecular sieve synthesized in example 1 as an additive, the yields of target distillate oils (LPG, petrol and diesel oil) are respectively increased by 5.71 wt % and 5.85 wt %, and the yields of cokes are respectively reduced by 1.92 wt % and 2.05 wt %.

The hierarchical mordenite synthesized in example 2 and a commercial microporous mordenite (purchased from the Catalyst Factory of Nankai University) are respectively applied to catalytic cracking of heavy oil. Xinjiang vacuum residue is selected as a reactant, and the reaction is carried out on a micro-fixed fluidized bed. The reaction conditions are as follows: the cracking temperature is 520° C., a mass ratio of an agent to oil is 12, a mass ratio of water to oil is 0.28, the injection time of feed oil is 45 s, and the loading amount of the catalyst is 50 g. The evaluation results are seen in Table 2. Compared with the commercial mordenite, the yield of target distillate oil (LPG, petrol and diesel oil), in the product obtained by the catalyst prepared with the hierarchical mordenite synthesized in example 2 as an additive, the yield of target distillate oil (LPG, petrol and diesel oil) is increased by 4.86 wt %, and the yield of coke is reduced by 1.24 wt %.

The hierarchical Beta molecular sieve synthesized in example 3 and a commercial microporous Beta molecular sieve (purchased from Nankai University Catalyst Factory) are respectively applied to hydrocracking of low-quality catalytic diesel oil. The catalytic diesel oil from Hohhot Petrochemical Company is selected as a reactant, and the reaction is carried out on a small fixed bed. The reaction conditions are as follows: the reaction temperature is 410° C., the reaction pressure is 6.5 MPa, a volume ratio of hydrogen to oil is 800, and the loading amount of the catalyst is 10 g. The evaluation results are seen in Table 3. Compared with the commercial microporous Beta molecular sieve, in the product obtained by the catalyst prepared by using the hierarchical Beta molecular sieve synthesized in example 3 as an additive, the yield of the petrol is increased by 7.69 wt %, and the yield of the coke is decreased by 2.24 wt %.

The hierarchical Y-type molecular sieve synthesized in example 4 and a commercial microporous Y-type molecular sieve (purchased from Nankai University Catalyst Factory) are respectively applied to hydrocracking of low-quality catalytic diesel oil. The catalytic diesel oil from Hohhot Petrochemical Company is selected as a reactant, and the reaction is carried out on a small fixed bed. The reaction conditions are as follows: the reaction temperature is 400° C., the reaction pressure is 6.5 MPa, a volume ratio of hydrogen to oil is 900, and the loading amount of the catalyst is 10 g. The evaluation results are seen in Table 4. Compared with the commercial microporous Y-type molecular sieve, in the product obtained by the catalyst prepared by using the hierarchical Beta molecular sieve synthesized in example 4 as an additive, the yield of the petrol is increased by 6.55 wt %, and the yield of the coke is decreased by 2.29 wt %.

The hierarchical ZSM molecular sieve synthesized in example 5 and a commercial microporous ZSM-5 molecular sieve (purchased from Nankai University Catalyst Factory) are respectively applied to hydrocracking of low-quality catalytic diesel oil. The catalytic diesel oil from Hohhot Petrochemical Company is selected as a reactant, and the reaction is carried out on a small fixed bed. The reaction conditions are as follows: the reaction temperature is 420° C., the reaction pressure is 6.5 MPa, a volume ratio of hydrogen to oil is 800, and the loading amount of the catalyst is 10 g. The evaluation results are seen in Table 5. Compared with the commercial microporous ZSM-5 molecular sieve, in the product obtained by the catalyst prepared by using the hierarchical Beta molecular sieve synthesized in example 5 as an additive, the yield of the target distillate oil is increased by 5.57 wt %, and the yield of the coke is decreased by 1.57 wt %.

TABLE 1
Application evaluation results of molecular sieves synthesized
in example 1, comparative example 1 and comparative example 2

| | Catalysts | | |
|---|---|---|---|
| | | Comparative | Comparative |
| Yield of product (wt %) | Example 1 | example 1 | example 2 |
| Gas | 5.32 | 6.50 | 6.94 |
| LPG | 33.16 | 30.65 | 30.90 |
| Petrol | 38.22 | 36.19 | 35.49 |
| Diesel oil | 10.81 | 9.64 | 9.95 |
| Heavy oil | 8.56 | 10.53 | 10.42 |
| Coke | 3.97 | 5.89 | 6.02 |
| Yield of liquid (wt %) | 90.75 | 87.01 | 86.76 |
| Conversion rate (wt %) | 80.63 | 80.12 | 79.73 |

TABLE 2
Application evaluation results of a molecular
sieve synthesized in example 2

Catalysts

| Yield of product (wt %) | Example 2 | Commercial mordenite |
|---|---|---|
| Gas | 2.43 | 4.33 |
| LPG | 17.73 | 18.21 |
| Petrol | 46.48 | 42.33 |
| Diesel oil | 15.07 | 13.80 |
| Heavy oil | 13.58 | 16.89 |
| Coke | 2.45 | 3.69 |
| Yield of liquid (wt %) | 92.86 | 91.23 |
| Conversion rate (wt %) | 69.65 | 68.04 |

TABLE 3
Application evaluation results of a molecular
sieve synthesized in example 3

| | Catalysts | |
|---|---|---|
| Yield of product (wt %) | Example 3 | Commercial Beta molecular sieve |
| Gas | 4.53 | 6.94 |
| Light petrol | 43.56 | 39.28 |
| Heavy petrol | 12.43 | 9.02 |
| Diesel oil | 36.81 | 39.85 |
| Coke | 2.67 | 4.91 |
| Yield of liquid (wt %) | 92.80 | 88.15 |
| Conversion rate (wt %) | 63.19 | 60.15 |

TABLE 4
Application evaluation results of a molecular
sieve synthesized in example 4

| | Catalysts | |
|---|---|---|
| | | Commercial Y type molecular |
| Yield of product (wt %) | Example 4 | sieve |
| Gas | 3.67 | 5.64 |
| Light petrol | 45.56 | 42.45 |
| Heavy petrol | 13.78 | 10.34 |
| Diesel oil | 34.87 | 37.16 |
| Coke | 2.12 | 4.41 |
| Yield of liquid (wt %) | 94.21 | 89.95 |
| Conversion rate (wt %) | 65.13 | 62.84 |

TABLE 5
Application evaluation results of a molecular
sieve synthesized in example 5

| | Catalysts | |
|---|---|---|
| | | Commercial ZSM-5 molecular |
| Yield of product (wt %) | Example 5 | sieve |
| Gas | 5.23 | 7.12 |
| Light petrol | 32.89 | 30.45 |
| Heavy petrol | 20.65 | 17.34 |
| Diesel oil | 38.87 | 41.16 |
| Coke | 2.36 | 3.93 |
| Yield of liquid (wt %) | 92.41 | 88.95 |
| Conversion rate (wt %) | 61.13 | 58.84 |

What is claimed is:

1. A preparation method of a function type active aluminosilicate, wherein a natural aluminosilicate mineral, an organic acid salt and an alkali metal hydroxide solution are mixed and pulped, and then the natural aluminosilicate mineral and the organic acid salt in slurry are respectively depolymerized and carbonized in a spray drier to obtain the function type active aluminosilicate.

2. The preparation method of the function type active aluminosilicate according to claim 1, specifically comprising the following process steps:
(1) formulating an alkali metal hydroxide into the alkali metal hydroxide solution;
(2) mixing and violently stirring a natural aluminosilicate mineral, an organic acid salt and the alkali metal hydroxide solution from step (1) to obtain slurry;
(3) pouring the slurry obtained in step (2) through the inlet of the spray dryer, dispersing the slurry into 10-30 μm droplets via an airflow type atomizer with a pressure of 0.2-0.5 MPa, making the obtained droplets be in direct contact with high-temperature hot air after entering a drying chamber, and allowing the droplets to stay for 30-300 s in the drying chamber and then spraying out from an outlet of the spray drier to obtain a powdered solid, namely, the function type active aluminosilicate.

3. The preparation method of the function type active aluminosilicate according to claim 2, wherein in step (1), the alkali metal hydroxide is one or more of NaOH, KOH and LiOH, the alkali metal hydroxide solution is an alkali metal hydroxide aqueous solution, and the concentration of the alkali metal hydroxide aqueous solution is 0.05-0.3 g/mL.

4. The preparation method of the function type active aluminosilicate according to claim 2, wherein in step (2), the natural aluminosilicate mineral comprises one or more of feldspar, nepheline, leucite, beryl, muscovite, pyrophyllite, kaolinite, rectorite, jadeite, spodumene, diaspore, perlite, cordierite, phlogopite, vermiculite, montmorillonite, talc, serpentine, illite, palygorskite, sepiolite, attapulgite, enstatite, diopside, amphibole and olivine, wherein the natural aluminosilicate mineral has an impurity content of less than 20 wt % and a particle size of no more than 200 mesh.

5. The preparation method of the function type active aluminosilicate according to claim 2, wherein in step (2), the organic acid salt comprises one or more of sodium citrate, sodium tartrate, sodium malate, sodium oxalate, potassium citrate, potassium tartrate, potassium malate, potassium oxalate, lithium citrate, lithium tartrate, lithium malate and lithium oxalate.

6. The preparation method of the function type active aluminosilicate according to claim 2, wherein in step (2), a mass ratio of the natural aluminosilicate mineral to the organic acid salt is 4-10:1, and a ratio of the natural aluminosilicate mineral to the alkali metal hydroxide aqueous solution is 0.05-0.5 g/mL.

7. The preparation method of the function type active aluminosilicate according to claim 2, wherein in step (2), when the natural aluminosilicate mineral is mixed with the alkali metal hydroxide aqueous solution, the stirring rotation speed is 600-1600 rpm/min, and the stirring time is 10-120 min.

8. The preparation method of the function type active aluminosilicate according to claim 2, wherein in step (3), the inlet temperature and the outlet temperature of the spray drier are respectively set as 120-250° C. and 50-150° C., and the temperature of the drying chamber is set as 160-280° C.

9. The function type active aluminosilicate prepared by the method according to any one of claims 1-8.

10. Use of the function type active aluminosilicate according to claim 9 in synthesis of a hierarchical molecular sieve.
